(19) United States
(12) Patent Application Publication
(10) Pub. No.: US 2024/0391822 A1
(43) Pub. Date: Nov. 28, 2024

(54) THERMOCHROMIC FILM AND METHOD FOR MANUFACTURING THERMOCHROMIC FILM

(71) Applicant: KOREA INSTITUTE OF INDUSTRIAL TECHNOLOGY, Cheonan-si,Chungcheongnam-do (KR)

(72) Inventors: Kwang Seok KIM, Jeonju-si, Jeollabuk-do (KR); Jung Pil KIM, Jeonju-si, Jeollabuk-do (KR); Myoung Hun KIM, Wanju-gun, Jeollabuk-do (KR)

(21) Appl. No.: 18/685,672

(22) PCT Filed: Aug. 23, 2022
(86) PCT No.: PCT/KR2022/012572

§ 371 Date: Feb. 22, 2024

(30) Foreign Application Priority Data
Aug. 23, 2021 (KR) 10-2021-0111011
Aug. 23, 2021 (KR) 10-2021-0111012

(51) Int. Cl. C03C 17/25; G02F 1/01

(52) U.S. Cl. CPC C03C 17/25; G02F 1/0147; C03C 2218/11; C03C 2218/32; G02F 2201/56

(57) ABSTRACT

The present invention provides a thermochromic film in which vanadium dioxide can be used without a doping process after the phase transition temperature thereof is reduced, and thus, there are economic and environmental advantages, and a method for manufacturing a thermochromic film, the method comprising: a formation step of forming a coating layer by applying a solution including untreated vanadium oxide onto a substrate; and a formation step of forming a thermochromic layer by phase change of untreated vanadium oxide to vanadium dioxide through annealing using intense pulsed light (IPL).

### TECHNICAL FIELD

The present invention relates to a thermochromic film and a method of manufacturing the thermochromic film, and more particularly, to a thermochromic film including a thermochromic layer whose phase transition temperature changes, and a method of manufacturing the thermochromic film using IPL annealing.

This invention was carried out through the following project support.
Research Identification Number: 2021-GJ-RD-0074
Ministry Name: Ministry of Science and Information & Communications Technology (ICT)
Research Management Specialized Organization: National Research Foundation of Korea
Research Program Name: Special research and development zone development R&D project
Research Project Name: Development of a reversible heat-blocking functional window system using large-area in-line spray coating
Contribution Rate: 1/2
Lead Organization: Seongil Innotek Co., Ltd.
Research Period: Jun. 1, 2021 to Mar. 31, 2022

### BACKGROUND ART

As the shortcomings of conventional coal, petroleum, and nuclear energy sources have become more prominent, the need to develop new alternative energy sources has recently increased. However, it is equally important to control energy consumption. In fact, more than 60% of the energy consumption in typical households is used for cooling and heating. In particular, the energy consumed through windows in general houses and buildings reaches 24%. Therefore, in order to reduce the energy consumed through windows, various efforts are being made, ranging from a method of adjusting the sizes of windows to a method of installing highly insulating window glass.

For example, research on thermochromic glass, which regulates energy input by being coated with a thermochromic layer having thermochromism to control infrared transmittance, is ongoing.

Thermochromism is a phenomenon in which the color of the oxide or sulfide of any transition metal reversibly changes at the phase transition temperature (or critical temperature). When glass is coated with such a thermochromic material, it is possible to manufacture thermochromic glass that transmits visible light but blocks near-infrared and infrared rays at a temperature higher than a certain temperature, thereby preventing the indoor temperature from rising. By using these characteristics, it is possible to suppress the rise in indoor temperature by shielding near-infrared light during high summer temperatures, and to bring in light energy from the outside during low winter temperatures. When such thermochromic glass is used in building windows or doors, a significant energy saving effect can be expected.

Materials that exhibit a thermochromic effect include oxides or sulfides of various phase transition metals. Among them, research is mainly being conducted on the use of vanadium dioxide (VO₂), which has a phase transition temperature of 68° C.

Meanwhile, because vanadium dioxide has a high phase transition temperature, it is difficult to use vanadium dioxide as it is, especially as windows or doors. Therefore, there have been efforts to lower the phase transition temperature. In recent years, the phase transition temperature has been controlled through doping of tungsten and the like, but this doping method causes environmental issues due to complicated processes, treatment of residues after the processes, and the like, and worsens the hysteresis characteristics. Therefore, there is a need for a method to replace such a doping method.

On the other hand, vanadium dioxide (VO₂) may be manufactured by inducing a phase change of vanadium pentoxide (V₂O₅). In the prior art, the phase change was induced by applying a solution containing vanadium pentoxide (V₂O₅) onto a substrate and then performing a high-temperature heat treatment process. However, even when this heat treatment process deteriorates optical properties, there are problems in that a diffusion prevention layer is inevitably used to prevent heat diffusion and it is difficult to apply it to heat-sensitive substrates such as polymers and the like.

### DISCLOSURE

### Technical Problem

The present invention is directed to providing a thermochromic film whose phase transition temperature of a thermochromic layer can be changed through a change in stress through a substrate having heat shrinkability, and which thus has economic and environmental advantages because the thermochromic film is applicable to various fields, and does not undergo the conventional complicated doping and post-treatment processes, and a method of manufacturing a thermochromic film through which a phase change of vanadium oxide can be induced without a diffusion prevention layer, and a thermochromic film can be manufactured even when the substrate is made of a heat-sensitive material such as a polymer substrate.

### Technical Solution

In order to solve the above problems, according to one aspect of the present invention, there is provided a thermochromic film which includes a substrate having heat shrinkability; and a thermochromic layer whose phase transition temperature changes due to heat shrinkage of the substrate and which is formed on the substrate.

According to another aspect of the present invention, there is provided a method of manufacturing a thermochromic film, which includes a formation step of forming a coating layer by applying a solution including untreated vanadium oxide (VOₓ) onto a substrate; and a preparation step of preparing a thermochromic layer by phase-changing the untreated vanadium oxide (VOₓ) to vanadium dioxide (VO₂) through annealing using intense pulsed light (IPL).

### Advantageous Effects

A thermochromic film according to the present invention has economic and environmental advantages because the phase transition temperature of a thermochromic layer can be changed through a substrate having heat shrinkability without complicated doping and post-treatment processes.

Also, a manufacturing method according to the present invention has advantages of being able to induce a phase change of vanadium oxide without a diffusion barrier layer that deteriorates optical properties using IPL annealing, and also to manufacture a thermochromic film even when the substrate is made of a heat-sensitive material such as a polymer substrate.

### DESCRIPTION OF DRAWINGS

FIG. 1 is a diagram showing a structure of a thermochromic film according to the present invention.

FIG. 2 is a diagram showing the direction of stress during heat shrinkage of a substrate according to the present invention.

FIG. 3 is a diagram for easily explaining the direction of shrinkage and the direction of stress during heat shrinkage of the substrate.

FIG. 4 is a graph measuring the transmittance of a thermochromic film manufactured in Example 1.

FIG. 5 is a graph showing the thermochromic characteristics of a thermochromic film manufactured according to Example 2.

FIGS. 6 and 7 are graphs showing the thermochromic characteristics of a thermochromic film manufactured as the control in Example 2.

FIG. 8 is a graph showing the thermochromic characteristics of a thermochromic film manufactured according to Example 3.

### BEST MODE

The terminology used in this specification will be described briefly, and the present invention will be described in detail.

The terms used in the present invention are selected from general terms which are currently as widely used as possible in the art in consideration of functions in the present invention, but the terms may vary according to the intention of those skilled in the art, precedents, or the emergence of new technology in the art. In certain cases, specified terms are also selected arbitrarily by the applicant, and in these cases, the detailed meaning thereof will be described in the corresponding detailed description of the invention. Thus, the terms used in the present invention should be defined based not on simple names but on the meanings of the terms and the overall description of the present invention.

Hereinafter, embodiments of the present invention will be described in detail with reference to the accompanying drawings so that those with ordinary skill in the art to which the present invention pertains may easily carry out the embodiments of the present invention. However, the present invention may be implemented in various different ways, and is not limited to the exemplary embodiments described herein. Parts irrelevant to the detailed description will be omitted in the drawings in order to clearly describe the present invention, and similar elements will be designated by similar reference numerals throughout the specification.

Hereinafter, the present invention will be described in detail with reference to the accompanying drawings.

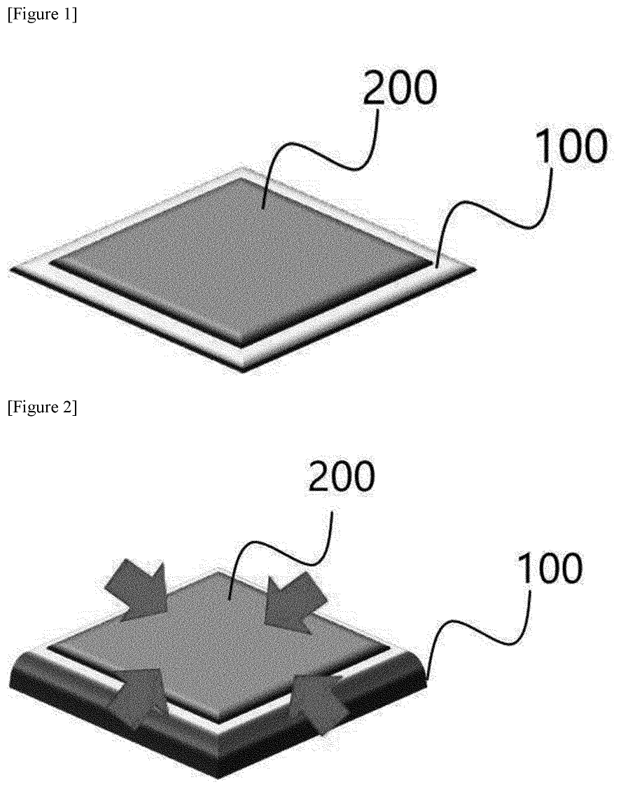

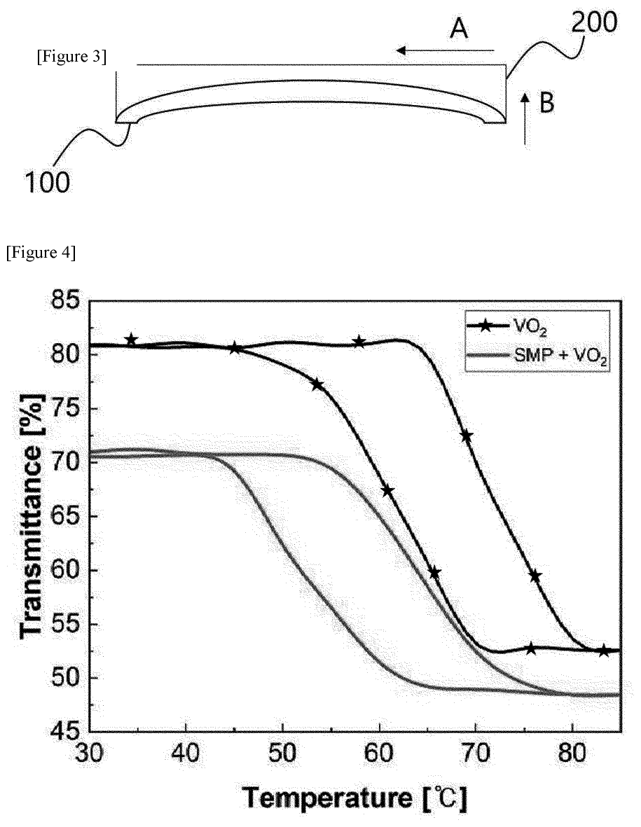

FIG. 1 is a diagram showing a structure of a thermochromic film according to the present invention, FIG. 2 is a diagram showing the direction of stress during heat shrinkage of a substrate according to the present invention, and FIG. 3 is a diagram for easily explaining the direction of shrinkage and the direction of stress during heat shrinkage of the substrate.

The thermochromic film of the present invention includes a substrate 100 and a thermochromic film 200.

Specifically, the thermochromic film of the present invention includes a substrate 100 having heat shrinkability; and a thermochromic layer 200 whose phase transition temperature changes due to thermal shrinkage of the substrate 100 and which is formed on the substrate.

When heat is applied to the substrate 100, the shrinking property may be achieved, and the shrinking force may act as stress on the thermochromic layer, thereby changing the phase transition temperature of the thermochromic layer. For example, stress may occur from the edge to the center of the thermochromic layer 200 during heat shrinkage of the substrate 100 (see FIG. 2). For example, the thermal shrinkage rate of the substrate 100 may be approximately 2%. In this case, the stress occurring in the thermochromic layer 200 may be approximately 2 GPa.

According to the present invention, the thermochromic characteristics of the thermochromic layer 200 may be ultimately controlled by inducing a change in the phase transition temperature of the thermochromic layer 200 through a change in stress of the substrate 100.

According to one embodiment, the phase transition temperature of the thermochromic layer 200 may decrease during the heat shrinkage of the substrate 100. The change rate of the phase transition temperature varies depending on the magnitude of stress due to the heat shrinkage. For example, when the heat shrinkage rate of the substrate 100 is 2% and the resulting stress is 2 GPa, the phase transition temperature may decrease by approximately 10° C.

According to one exemplary embodiment, the substrate 100 has a curved surface. In this case, the curvature of the curved surface may be gently deformed during the heat shrinkage. Referring to FIG. 3, the edge of the curved surface moves in the direction B during heat shrinkage so that the curvature of the curved surface can be gently deformed. Also, as the curvature of the curved surface is gently deformed, stress (or compressive stress) may be applied to the thermochromic layer 200 formed on the substrate 100 in the direction A.

According to one embodiment, the substrate 100 may include a shape memory polymer (SMP). The term “shape memory polymer” refers to a polymer that has a property of returning to its original shape, that is, a polymer material that remembers its shape taken under certain conditions and then returns to its original shape even after the shape changes when the conditions are again applied thereto. In the present invention, the shape memory polymer has heat shrinkability. In this case, the specific condition for the shape memory polymer may be to apply heat.

The glass transition temperature of the shape memory polymer may be 30° C. or more, 40° C. or more, 50° C. or more, 60° C. or more, 70° C. or more, 80° C. or more, or 100° C. or more. As long as the glass transition temperature is within the above range, the shape memory polymer may be appropriately selected in consideration of realizing desired physical properties, but the present invention is not limited thereto. For example, the shape memory polymer may be a urethane-based shape memory polymer. Urethane-based shape memory polymers have the advantage of exhibiting the shape memory property even at a low temperature due to low glass conductivity, and thus exhibit excellent handling and processability.

According to one exemplary embodiment, the thermochromic layer may include vanadium oxide. For example, the vanadium oxide may be vanadium dioxide. Specifically, the thermochromic layer 200 may include a vanadium dioxide cluster. As described above, the term “vanadium dioxide cluster” refers to an aggregate formed when an organic solvent in a solution including vanadium dioxide particles is removed and adhesion between the vanadium dioxide particles occurs through a sintering process. Because the vanadium dioxide (cluster) has thermochromic characteristics due to phase transition, the phase transition temperature of the thermochromic layer 200 may be ultimately controlled in the present invention through the magnitude of stress on the substrate 100, which makes it possible to control the thermochromic properties.

The thickness of the substrate 100 may range from 50 to 200 μm, but the present invention is not particularly limited thereto. In this case, the magnitude of stress applied to the thermochromic layer may be controlled by adjusting the thickness of the substrate.

The thermochromic film may have a maximum transmittance of 50% or more in the range of 400 to 800 nm. The layered product has a maximum transmittance (Pₘₐₓ) of 50% or more, 55% or more, 60% or more, or 65% or more in the region of 400 to 800 nm, and a minimum transmittance (OPₘᵢₙ) of 70% or less, 60% or less, specifically, 55% or less, 50% or less, or 40% or less in the region of 2,000 to 3,000 nm at any temperature greater than or equal to the critical temperature. When the Pₘₐₓ value is 50% or more, clear vision may be secured due to high visible light transmittance. On the other hand, when the OPₘₐₓ value is 65% or less, the infrared blocking effect may be excellent.

The thermochromic film may satisfy the conditions of the following General Expression 1:

$$Δ I R = B {P}_{min} - O {p}_{min} \geq 10 \% \qquad [ General Expression 1 ]$$

wherein BPₘᵢₙ represents the minimum transmittance in the range of 2,000 to 3,000 nm at any temperature less than or equal to the critical temperature, and OPₘᵢₙ represents the minimum transmittance in the range of 2,000 to 3,000 nm at any temperature greater than or equal to the critical temperature. Here, the temperature less than or equal to the critical temperature may, for example, range from 20 to 30° C., specifically 25° C., and the temperature greater than or equal to the critical temperature may, for example, range from 60 to 90° C., specifically 80° C. When the ΔIR value (%) is 10% or more, specifically 20% or more, 25% or more, 30% or more, or 35% or more, the effect on blocking/transmission of infrared rays may be excellent.

This application also relates to a method of manufacturing the above-described thermochromic film. For example, the method includes applying a thermochromic precursor solution onto a substrate having heat shrinkability; and photosintering the thermochromic precursor solution to form a thermochromic layer.

According to one embodiment, the thermochromic precursor solution may include vanadium oxide.

This application relates to another method of manufacturing the thermochromic film using IPL annealing.

The manufacturing method includes a formation step of forming a coating layer by applying a solution including untreated vanadium oxide (VOₓ) onto a substrate; and a preparation step of preparing a thermochromic layer by phase-changing the untreated vanadium oxide (VOₓ) to vanadium dioxide (VO₂) through annealing using intense pulsed light (IPL). In this specification, “untreated vanadium oxide” may be used in a limited sense to indicate vanadium oxide in which no phase change has occurred. The untreated vanadium oxide may exist in the form of particles or ions in a solution, and various known materials that dissolve vanadium oxide may be used as a solvent without limitation. Also, various methods such as spin coating, slot die coating, spray coating, and the like may be used for the application.

Because the method according to the present invention uses IPL instead of conventional high-temperature heat treatment, it is possible to manufacture a thermochromic film even when the substrate is made of a heat-sensitive material such as a polymer substrate.

For example, the untreated vanadium oxide (VOₓ) may be vanadium pentoxide (V₂O₅).

Meanwhile, in order to induce a phase change of vanadium oxide using IPL and prevent deformation of a heat-sensitive polymer substrate, it is important to optimally set the specific annealing conditions, such as an annealing atmosphere, the type of light, an applied voltage (an output voltage), the pulse width, the number of pulses (the number of repeated light irradiations), and the pulse interval (frequency).

According to one embodiment, the annealing may be performed in a vacuum or air atmosphere. Specifically, the vacuum atmosphere may be a vacuum atmosphere of 1 to 20 Torr.

In the annealing of the manufacturing method according to the present application, various conditions of the IPL, such as the pulse width, the pulse interval, the number of repetitions, and the like, which will be described later, have to be optimized depending on the vacuum or air atmosphere to enable a phase change of vanadium oxide. In the annealing, the values of the optimized conditions may vary depending on the vacuum atmosphere and the air atmosphere.

For example, in the vacuum atmosphere, the output voltage of the intense pulsed light may range from 1,500 to 1,900 V. As the output voltage increases, a phase change may occur more effectively, but physical deformation of the polymer film may occur. In this case, the appropriate voltage at which the physical deformation does not occur may range from 1,500 to 1,750 V.

According to another embodiment, in the air atmosphere, the output voltage of the intense pulsed light may range from 1,700 to 2,000 V. As the output voltage increases, a phase change may occur more effectively, but physical deformation of the polymer film may occur. In this case, the appropriate voltage at which the physical deformation does not occur may range from 1,750 to 1,900 V.

Also, the annealing may be performed by repetitive light irradiation with a constant pulse interval and pulse width. To enable a phase change of vanadium oxide, the pulse interval, the pulse width, and the number of repetitions have to be adjusted to an optimized numerical range as will be described later, depending on the vacuum atmosphere and the air atmosphere.

Specifically, in the vacuum atmosphere, the pulse width may range from 1 to 4 ms. Also, in the vacuum atmosphere, the pulse interval may range from 0.2 to 1 Hz. As the pulse interval decreases, the process time may be reduced due to an increase in average power applied per second. The average power is determined by the output voltage, the pulse width, and the pulse interval. However, when the pulse interval is less than 0.2 Hz, no phase change may occur because the accumulated heat energy may escape from the bed. On the other hand, when the pulse interval is greater than 1 Hz, the bed temperature may rise rapidly, thereby causing physical deformation of the polymer film.

According to one embodiment, in the vacuum atmosphere, the number of repetitions of annealing (or light irradiation) may range from 20 to 200. As the number of repetitions increases, the visible light transmittance and infrared transmittance of the manufactured thermochromic layer may improve, but when the number of repetitions exceeds a certain number, the substrate may be deformed, which results in decreased transmittance of the thermochromic layer. For example, the infrared transmittance improves until the number of repetitions reaches 200, and the visible light transmittance and infrared transmittance deteriorate when the number of repetitions is greater than 250. Accordingly, the appropriate number of repetitions may range from 20 to 200, from 50 to 200, from 100 to 200, or may be approximately 200.

According to another embodiment, in the air atmosphere, the pulse width may range from 0.1 to 1 ms, for example, from 0.2 to 1 ms, from 0.3 to 1 ms, from 0.4 to 1 ms, or from 0.5 to 1 ms. Also, in the air atmosphere, the pulse interval may range from 1.0 to 3.0 Hz, for example, from 1.1 to 3.0 Hz, from 1.2 to 3.0 Hz, from 1.0 to 2.5 Hz, from 1.1 to 2.5 Hz, from 1.2 to 2.5 Hz, from 1.0 to 2.0 Hz, from 1.1 to 2.0 Hz, or from 1.2 to 2.0 Hz. As the pulse interval decreases, the process time may be reduced due to an increase in average power applied per second. The average power is determined by the output voltage, the pulse width, and the pulse interval. However, when the pulse interval is less than 1.0 Hz, no phase change may occur because the accumulated heat energy may escape from the bed. On the other hand, when the pulse interval is greater than 3.0 Hz, the bed temperature may rise rapidly, thereby causing physical deformation of the polymer film.

According to one embodiment, in the air atmosphere, the number of repetitions of annealing (or light irradiation) may range from 200 to 400. As the number of repetitions increases, the visible light transmittance and infrared transmittance of the manufactured thermochromic layer may improve, but when the number of repetitions exceeds a certain number, the substrate may be deformed, which results in decreased transmittance of the thermochromic layer. For example, the infrared transmittance improves until the number of repetitions reaches 400, and the visible light transmittance and infrared transmittance deteriorate when the number of repetitions is greater than 450. Accordingly, the appropriate number of repetitions may range from 200 to 400, 200 to 350, 200 to 300, or may be approximately 250.

According to one exemplary embodiment, the type of substrate may be selected from a glass, quartz, or polymer film. In particular, considering the usability of flexible devices, the substrate may be selected as a polymer film. Here, types of such polymer films that may be used herein include polyolefin films (e.g., cycloolefin, polyethylene, polypropylene, and the like), polyester films (e.g., polyethylene terephthalate, polyethylene naphthalate), polyvinyl chloride, and cellulose-based films (e.g., triacetyl cellulose), but the present invention is not particularly limited thereto.

Specifically, the polymer film may include a polymer having a glass transition temperature of 70° C. or more, 80° C. or more, 90° C. or more, 100° C. or more, 110° C. or more, or 120° C. or more. As long as the glass transition temperature satisfies the above range, the type of the polymer film is not particularly limited, and may be appropriately selected in consideration of realizing desired physical properties. For example, when the polymer film is a polyethylene naphthalate film, excellent heat resistance may be achieved.

Also, polymer films, which are elongated in a direction of one axis or more and have a shrinkage rate of less than 3% when exposed to 120° C. for an hour, may be, for example, used as the polymer film. When the elongated polymer film is used, it may have excellent mechanical strength and prevent shrinkage at a high temperature. A polymer film that satisfies these requirements may be optionally selected from known materials and used.

Meanwhile, when the annealing is performed in an air atmosphere, the thickness of the coating layer and the average particle size of untreated vanadium oxide (VOₓ) have to be controlled within numerical ranges below to enable the phase change induction of vanadium oxide.

According to one embodiment, the thickness of the coating layer may range from 10 to 300 nm or less, and the average particle size of untreated vanadium oxide (VOₓ) may range from 1 to 40 nm or less. In this specification, unless particularly specified otherwise, the average particle size may be an average particle size measured according to D50 particle size analysis.

### MODE FOR INVENTION

Hereinafter, the present invention will be described in detail with reference to embodiments thereof. However, it will be evident that the embodiments described in the specification and the configuration shown in the drawings are merely illustrative of the most preferred embodiments of the present invention, and do not represent the entire technical idea of the present invention. Accordingly, it should be understood that there may be various equivalents and modifications that can replace them at the time of filing this application.

### Example 1

A solution including vanadium dioxide was coated on glass with a size of 10×10 mm², which was a substrate including a urethane-based shape memory polymer (SMP), at 1,000 rpm for 30 seconds using a spin coater (ACE-200, Dong-A Trading Co., Ltd., Korea), and dried to manufacture a thermochromic film.

The transmittance of the thermochromic film manufactured in Example 1 when the temperature increased from 25° C. to 80° C. at 2,500 nm and then decreased again was measured using a spectrophotometer (JASCO V-770, JASCO, USA). The results are shown in FIG. 4. As a control, glass was used instead of the shape memory polymer.

As the thermochromic characteristics of vanadium dioxide are realized through the phase transition, the temperature at which the transmittance changes in FIG. 4 may be considered the phase transition temperature of vanadium dioxide. Therefore, it can be seen that when the SMP substrate was used, the phase transition temperature of vanadium dioxide decreased by 6.4° C. because compressive stress was applied to the substrate.

### Example 2

A solution including vanadium pentoxide was coated on glass with a size of 10×10 mm² at 1,000 rpm for 30 seconds using a spin coater (ACE-200, Dong-A Trading Co., Ltd., Korea).

Then, a thermochromic film was manufactured by performing IPL treatment 100 times at 1,900 V and 0.5 Hz for 2 ms in a vacuum atmosphere of 1 Torr.

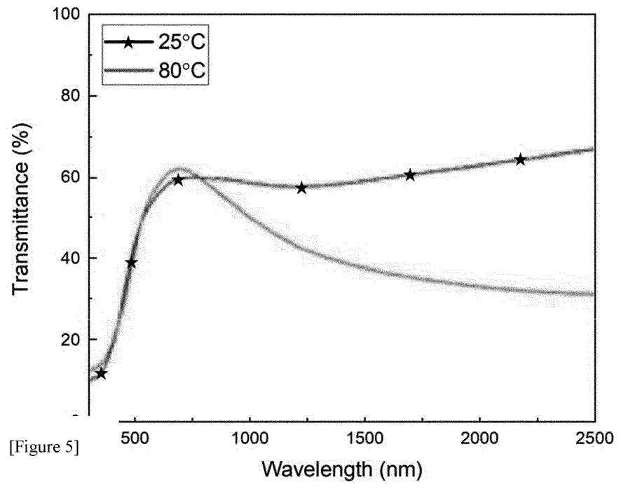

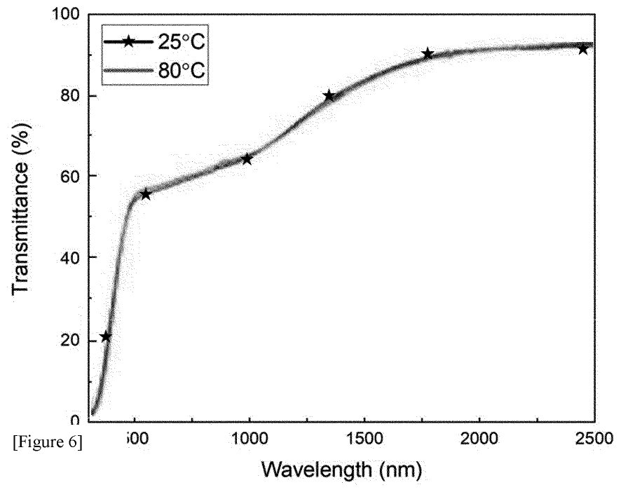

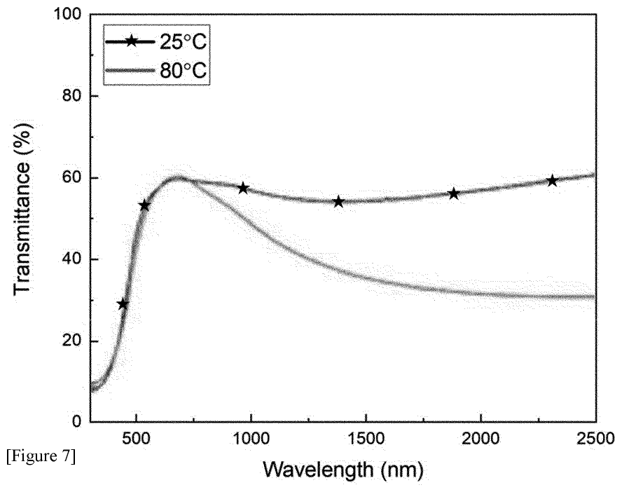

FIG. 5 is a graph showing the thermochromic characteristics of the thermochromic film manufactured in Example 2, and FIGS. 6 and 7 are graphs of showing the thermochromic characteristics of the thermochromic film manufactured as the control in Example 2.

Specifically, FIG. 6 is a graph showing the thermochromic characteristics of the thermochromic film manufactured by drying at room temperature instead of the IPL treatment in Example 2, and FIG. 7 is a graph showing the thermochromic characteristics of the thermochromic film manufactured by heat treatment at 500° C. for an hour in a vacuum atmosphere of 1 Torr instead of the IPL treatment in Example 2.

Referring to the drawing, the thermochromic film dried at room temperature did not exhibit thermochromic characteristics because the phase change of vanadium oxide did not occur (see FIG. 6), and the heat-treated thermochromic film exhibited thermochromic characteristics because the phase change of vanadium oxide occurred (see FIG. 7). As a result, it can be seen that the thermochromic film manufactured by the IPL treatment according to the present invention in a vacuum atmosphere also had the same effect as the heat-treated thermochromic film because the phase change of vanadium oxide occurred (see FIG. 5).

### Example 3

A solution containing vanadium pentoxide having an average particle size of 40 nm or less was coated on glass with a size of 10×10 mm² at 1,000 rpm for 30 seconds using a spin coater (ACE-200, Dong-A Trading Co., Ltd., Korea), and the thickness of the coating layer was 300 nm.

Then, a thermochromic film was manufactured by performing IPL treatment 300 times at 1,750 V and 1.2 Hz for 0.5 ms in an air atmosphere.

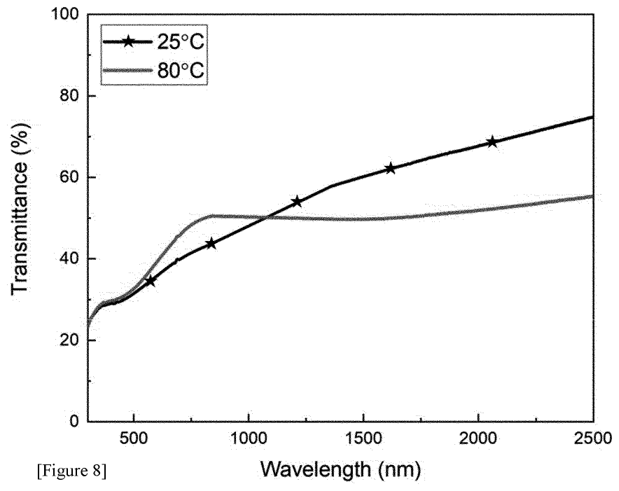

FIG. 8 is a graph showing the thermochromic characteristics of the thermochromic film manufactured in Example 3.

From the results of FIGS. 6 and 7 and FIG. 8, it can be seen that the thermochromic film manufactured by the IPL treatment according to the present invention in an air atmosphere also had the same effect as the heat-treated thermochromic film because the phase change of vanadium oxide occurred.

### BRIEF DESCRIPTION OF MAIN PARTS IN THE DRAWINGS

100: substrate
200: thermochromic layer

1. A thermochromic film comprising:
a substrate having heat shrinkability; and
a thermochromic layer whose phase transition temperature changes due to heat shrinkage of the substrate and which is formed on the substrate.

2. The thermochromic film of claim 1, wherein the phase transition temperature of the thermochromic layer decreases during heat shrinkage of the substrate.

3. The thermochromic film of claim 1, wherein the substrate has a curved surface, wherein the curvature of the curved surface is gently deformed during the heat shrinkage.

4. The thermochromic film of claim 1, wherein the substrate includes a shape memory polymer (SMP).

5. The thermochromic film of claim 4, wherein the shape memory polymer has a glass transition temperature of 30° C. or more.

6. The thermochromic film of claim 4, wherein the shape memory polymer is a urethane-based shape memory polymer.

7. The thermochromic film of claim 1, wherein the thermochromic layer includes vanadium oxide.

8. The thermochromic film of claim 1, wherein the substrate has a thickness ranging from 50 to 200 μm.

9. The thermochromic film of claim 1, wherein a layered product has a maximum transmittance of 50% or more in the range of 400 to 800 nm.

10. The thermochromic film of claim 1, wherein the layered product has a minimum transmittance of 70% or less in the range of 2,000 to 3,000 nm at any temperature greater than or equal to the critical temperature.

11. The thermochromic film of claim 1, wherein the layered product satisfies the conditions of the following General Expression 1:
ΔIR=BPₘᵢₙ−Opₘᵢₙ≥10% [General Expression 1]
wherein BPₘᵢₙ represents the minimum transmittance in the range of 2,000 to 3,000 nm at any temperature less than or equal to the critical temperature, and OPₘᵢₙ represents the minimum transmittance in the range of 2,000 to 3,000 nm at any temperature greater than or equal to the critical temperature.

12. A method of manufacturing a thermochromic film, comprising:
a formation step of forming a coating layer by applying a solution including untreated vanadium oxide (VOₓ) onto a substrate; and
a preparation step of preparing a thermochromic layer by phase-changing the untreated vanadium oxide (VOₓ) to vanadium dioxide (VO₂) through annealing using intense pulsed light (IPL).

13. The method of claim 12, wherein the untreated vanadium oxide (VOₓ) is vanadium pentoxide (V₂O₅).

14. The method of claim 12, wherein the annealing is performed in a vacuum or air atmosphere.

15. The method of claim 14, wherein the output voltage of the intense pulsed light in a vacuum atmosphere ranges from 1,500 to 1,900 V.

16. The method of claim 14, wherein the output voltage of the intense pulsed light in an air atmosphere ranges from 1,700 to 2,000 V.

17. The method of claim 14, wherein the annealing is performed by repetitive light irradiation with a constant pulse interval and pulse width.

18. The method of claim 16, wherein the pulse width in a vacuum atmosphere ranges from 1 to 4 ms.

19. The method of claim 16, wherein the pulse interval in a vacuum atmosphere ranges from 0.2 to 1 Hz.

20. The method of claim 16, wherein the number of repetitions in a vacuum atmosphere ranges from 20 to 200.

21. The method of claim 16, wherein the pulse width in an air atmosphere ranges from 0.1 to 1 ms or less.

22. The method of claim 16, wherein the pulse interval in an air atmosphere ranges from 1.0 to 3.0 Hz.

23. The method of claim 16, wherein the number of repetitions in an air atmosphere ranges from 200 to 400.

24. The method of claim 12, wherein the substrate is a glass, quartz, or polymer film.

25. The method of claim 24, wherein the polymer film includes a polymer having a glass transition temperature of 70° C. or more.

26. The method of claim 12, wherein the coating layer has a thickness of 10 to 300 nm or less.

27. The method of claim 12, wherein the untreated vanadium oxide (VOₓ) has an average particle size of 1 to 40 nm or less.
